(19) United States
(12) Patent Application Publication
(10) Pub. No.: US 2020/0341496 A1
(43) Pub. Date: Oct. 29, 2020

(54) Reducing Pressure Pulsations within a Fluid

(71) Applicant: Schlumberger Technology Corporation, Sugar Land, TX (US)

(72) Inventor: Joe Rodney Berry, Cypress, TX (US)

(21) Appl. No.: 16/392,729

(22) Filed: Apr. 24, 2019

(51) Int. Cl. G05D 16/20; E21B 41/00; E21B 21/08

(52) U.S. Cl. CPC G05D 16/2006; E21B 21/08; E21B 41/00

(57) ABSTRACT

Apparatus and methods for reducing pressure pulsations within a fluid. The apparatus may include a source of a gas, a pulsation dampener fluidly connected with the gas source and with the fluid containing the pressure pulsations, a pressure sensor operable to generate signals or information indicative of fluid pressure of the fluid containing the pressure pulsations, and a pressure regulator operable to control gas pressure of the gas within the pulsation dampener based on the fluid pressure.

### BACKGROUND OF THE DISCLOSURE

Fluid pumps are utilized at oil and gas wellsites to perform large scale, high-pressure pumping operations. Such operations may include drilling, cementing, acidizing, water jet cutting, and hydraulic fracturing of subterranean formations, and may utilize several pumps connected in parallel via a manifold and/or a plurality of fluid conduits to inject a fluid into a well. During certain operations, the pumps may inject the fluid into the well at pressures exceeding 10,000 pounds per square inch (PSI).

Reciprocating pumps, for example, may include reciprocating members driven by a crankshaft toward and away from a fluid chamber to alternatingly draw in, pressurize, and expel a fluid from the fluid chamber. Although reciprocating pumps have the ability to operate at different pressures, the pressurized fluid is discharged in an oscillating manner forming fluid pressure pulsations (i.e., spikes) at the pump outlets. The pressurized fluid is then transmitted through pipes and other fluid conduits connected downstream from the pumps. Such oscillating fluid pulsations may cause “noise” in signals or data (e.g., telemetry) transmitted between wellsite surface and downhole instrumentation. Pressure pulsations in the fluid may decrease performance of certain downhole operations, such as drilling operations, and may cause failures in piping, hose, and other downstream equipment. Pressure pulsations may also be amplified in pumping systems comprising two or more reciprocating pumps due to resonance phenomena caused by interaction of two or more fluid flows, further exacerbating the harmful effects of pressure pulsations.

Gas-charged pulsation dampeners may be connected at pump outlets to dampen or otherwise reduce magnitude of the pressure pulsations generated by the pumps. Such dampeners may include a gas-charged bladder within an internal chamber of a housing (e.g., a pressure vessel). The bladder may be charged with nitrogen or another gas. Gas-charged pulsation dampeners that do not include a bladder may also be utilized. During pumping operations, pressure pulsations within the pumped fluid compress the gas within the pulsation dampener, thereby reducing magnitude of the pressure pulsations transmitted downstream.

The gas-charged pulsation dampers operate optimally when pressure of the gas charge is set to match operating pressure of the pump. For example, the gas charge pressure may be set to about 50% of the operating pump pressure. However, pump operating pressure often varies during an oilfield pumping operation or between different jobs or job stages. For example, during drilling operations, pump pressure may vary based on well depth, whereby a pump may operate at lower pressures at shallow depths and at higher pressures at greater depths, such as when drilling in production zones. Typically, a gas-charged pulsation damper is charged to an average pressure of anticipated minimum and maximum pump operating pressures. However, charging the pulsation dampener to a single pressure results in less than optimal pulsation dampening effects since the gas charge does not match the operating pump pressure throughout entirety of the pumping operations, resulting in appreciable pressure pulsations being transmitted downstream from the pulsation dampers.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a system for reducing magnitude of pressure pulsations within a fluid. The system includes a source of a gas, a pulsation dampener, a pressure sensor, and a pressure regulator. The pulsation dampener is fluidly connected with the gas source and with the fluid containing the pressure pulsations. The pressure sensor generates signals or information indicative of fluid pressure of the fluid containing the pressure pulsations. The pressure regulator controls gas pressure of the gas within the pulsation dampener based on the fluid pressure.

The present disclosure also introduces a system for reducing magnitude of pressure pulsations within a fluid, the system including a gas source, a pulsation dampener, a first pressure sensor, a second pressure sensor, and a pressure modulator. The pulsation dampener is fluidly connected with the gas source and along a fluid conduit transmitting the fluid containing the pressure pulsations. The first pressure sensor generates signals or information indicative of pressure of the fluid containing the pressure pulsations. The second pressure sensor generates signals or information indicative of pressure of gas within the pulsation dampener. The pressure modulator automatically modulates the gas pressure within the pulsation dampener based on the fluid pressure while the fluid pressure changes.

The present disclosure also introduces a method including reducing magnitude of pressure pulsations within a fluid via a pulsation dampener while automatically changing pressure of a gas within the pulsation dampener to an intended gas pressure with respect to pressure of the fluid while the pressure of the fluid changes.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of an example implementation of apparatus according to one or more aspects of the present disclosure.

FIG. 2 is a schematic view of an example implementation of apparatus according to one or more aspects of the present disclosure.

FIG. 3 is a sectional side view of a portion of an example implementation of apparatus according to one or more aspects of the present disclosure.

FIG. 4 is a perspective view of an example implementation of apparatus according to one or more aspects of the present disclosure.

FIG. 5 is a side sectional view of the apparatus shown in FIG. 4.

FIG. 6 is a schematic view of an example implementation of apparatus according to one or more aspects of the present disclosure.

FIGS. 7 and 8 are graphs related to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

FIG. 1 is a schematic view of at least a portion of an example implementation of a pressure pulsation dampening system 100 operable to dissipate or otherwise reduce magnitude of the pressure pulsations (i.e., spikes) in a pumped fluid according to one or more aspects of the present disclosure. The dampening system 100 may comprise, be fluidly connected with, or otherwise be utilized with a gas-charged pressure pulsation dampener, such as comprising a gas-charged bladder, which may be fluidly connected along a discharge line of the pump to dissipate or otherwise reduce magnitude of the pressure pulsations in a pumped fluid 102. The dampening system 100 may be operable to measure pressure pulsations of the fluid discharged by the pump, calculate an average pulsation amplitude (e.g., root mean square (RMS)), and increase or decrease pressure of gas 104 (e.g., nitrogen) in the dampener bladder to actively minimize the average pressure pulsation amplitude within the pumped fluid 102. The dampening system 100 may be operable to modulate (i.e., regulate) the pressure of the gas 104 within the pulsation dampener in real-time (i.e., on-the-fly) during pumping operations based on the calculated average pulsation amplitude while the average pressure pulsation amplitude of the pumped fluid 102 changes. The calculated average pulsation amplitude may be a moving average that is calculated continuously during pumping operations.

The dampening system 100 may comprise a high speed pressure sensor 106 (i.e., transducer) operable to generate signals or information indicative of pressure of the pumped fluid 102 at a pump outlet (i.e., discharge). The dampening system 100 may also comprise a pressure sensor 108 fluidly connected with the gas-charged bladder of the pulsation dampener and operable to generate signals or information indicative of pressure of the gas 104 within the bladder. The pressure of the gas 104 may be modulated via a pressure regulator 110 (e.g., pressure modulator) fluidly connected between the pulsation dampener and a source of the gas (e.g., gas compressor). The signals or information generated by the pressure sensors 106, 108 may be transmitted to a controller 112 (e.g., computer, programmable logic controller (PLC), etc.), which may receive, process, and transmit corresponding control signals to the pressure regulator 110, to control the pressure regulator 110 and, thus, the pressure of the gas 104 within the bladder. The controller 112 may be operable to receive computer program code 114 (e.g., control commands or instructions), such as for calculating or otherwise determining the average fluid pressure of the pumped fluid. The control commands 114 may also comprise or set intended pressure level or relationship between the gas pressure and the calculated average fluid pressure. For example, the control commands 114 may set the pressure of the gas 104 to be 50% of the calculated average pressure of the pumped fluid 102, however other ratios and/or relationships between the gas 104 and fluid 102 pressures are also within the scope of the present disclosure. Accordingly, the dampening system 100 may be a closed-loop system operable to continually monitor and modulate the gas pressure being applied to the bladder of the pulsation dampener based the fluid pressure generated by the pump while pressure (e.g., average pressure) of the pumped fluid changes.

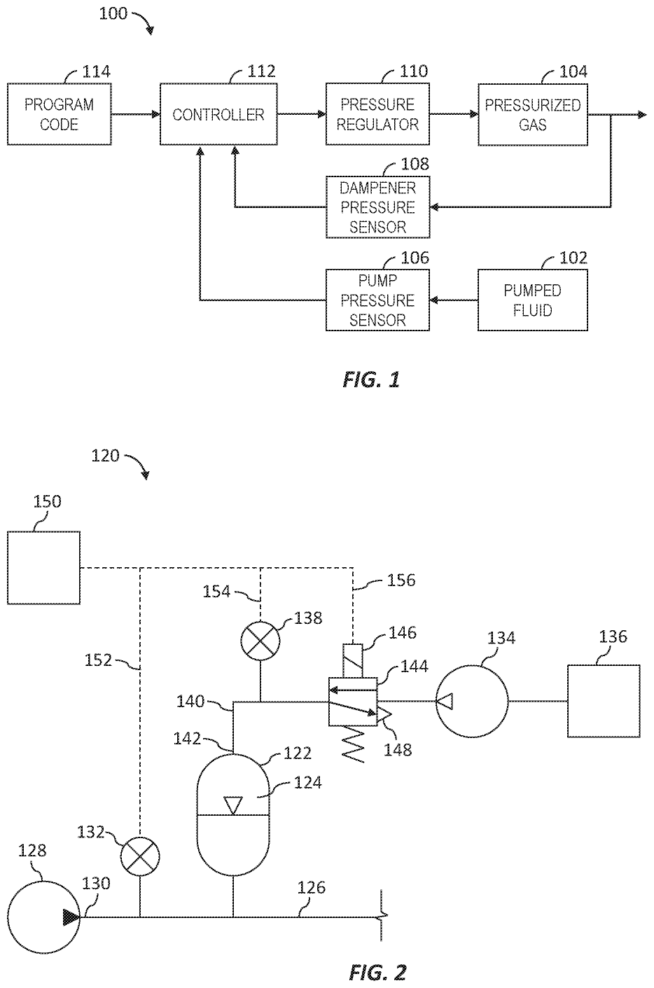

FIG. 2 is a schematic view of at least a portion of an example implementation of a pressure pulsation dampening system 120 operable to dissipate or otherwise reduce magnitude of the pressure pulsations in a pumped fluid according to one or more aspects of the present disclosure. The dampening system 120 may comprise one or more features of the dampening system 100 shown in FIG. 1.

The dampening system 120 may comprise, be fluidly connected with, or otherwise be utilized with a gas-charged pressure pulsation dampener 122, such as comprising a gas-charged bladder 124, which may be fluidly connected along a discharge line 126 of a pump 128 to dissipate or otherwise reduce magnitude of the pressure pulsations generated by the pump 128 within the fluid being pumped. The pulsation dampener 122 may be fluidly connected with or along the discharge line 126 in close proximity with an outlet 130 (i.e., discharge) of the pump 128. The dampening system 100 may further comprise a high speed pressure sensor 132 operable to generate signals or information indicative of fluid pressure along the discharge line 126. The pressure sensor 130 may be fluidly connected with or along the discharge line 126 between the pulsation dampener 122 and the pump outlet 132.

The dampening system 120 may further comprise a gas source, such as a gas compressor 134, for supplying pressurized gas to pulsation dampener 122. If the gas utilized to charge the pulsation dampener 122 is nitrogen, the gas source may further comprise source of nitrogen 136, such as a nitrogen generator or nitrogen storage containers (e.g., tanks containing liquefied nitrogen). The gas compressor 134 may receive the nitrogen from the nitrogen source 136 and pressurize the nitrogen to a predetermined pressure, such as a pressure that is about equal to the pressure of the pumped fluid. The dampening system 120 may also comprise a pressure sensor 138 fluidly connected with the bladder 124 and operable to generate signals or information indicative of pressure of the gas within the bladder 124. The pressure sensor 138 may be fluidly connected with or along a gas charge line 140 in close proximity with a gas inlet 142 of the pulsation dampener 122.

The pressure of the gas within the bladder 124 may be modulated via a pressure regulator 144 (e.g., a pressure modulator) fluidly connected with the bladder 124. The pressure regulator 144 may be fluidly connected with the gas charge line 140 between the pulsation dampener 122 and the gas source, such as the compressor 134 and/or the nitrogen source 136. The pressure regulator 144 may be remotely operated, such as via an electrically operated magnetic coil 146 (i.e., solenoid). The magnetic coil 146 may actuate the pressure regulator 146 to modulate or otherwise change downstream pressure and, thus, gas pressure within the bladder 124, to an intended level. The pressure regulator 144 may be operable to progressively adjust the downstream pressure, such as based on voltage applied to the magnetic coil 146. The pressure regulator 144 may increase the downstream pressure, for example, by permitting the gas to flow from the gas source 134, 136 into the bladder 124 through the pressure regulator 144 until the downstream pressure reaches the intended pressure. The pressure regulator 144 may decrease the downstream pressure, for example, by preventing gas flow from the gas source 134, 136 and/or relieving gas from the bladder 124 via a vent 148 until the downstream pressure reaches the intended pressure.

The pressure sensors 132, 138 and the pressure regulator 144 may be communicatively connected with a controller 150 via corresponding conductors 152, 154, 156. The signals or information generated by the pressure sensors 132, 138 may be transmitted to the controller 150, which may receive and process the signals or information and transmit corresponding control signals to the pressure regulator 144 to control the pressure regulator 144 and, thus, the pressure of the gas within the bladder 124. Similarly as described above with respect to the controller 112 shown in FIG. 1, the controller 150 may receive a computer program code (e.g., control commands or instructions), such as may be executed to calculate or otherwise determine the average fluid pressure of the fluid pumped by the pump 128. The control commands may also comprise or set intended pressure level or relationship between the gas pressure within the pulsation dampener 122 and the calculated average pressure of the fluid pumped by the pump 128. Accordingly, the controller 150 may continually (i.e., reiteratively) monitor operating pressure of the pump 128 and the gas charge pressure within the pulsation dampener 122, and modulate the gas charge pressure being applied to the pulsation dampener 122 via the pressure regulator 144 based on the operating pressure of the pump 128, such as to maintain a predetermined relationship between the operating pressure of the pump 128 and the gas charge pressure of the pulsation dampener 122. For example, the controller 150 may in real-time cause the pressure regulator 144 to increase the gas charge pressure within the pulsation dampener 122 while the operating pressure of the pump 128 increases and decrease the gas charge pressure within the pulsation dampener 122 while the operating pressure of the pump 128 decreases. Communication between the controller 150 and various sensors 132, 138 and/or actuators 146 of the dampening system 120 may also or instead be accomplished via wireless communication means. However, for clarity and ease of understanding, such communication means are not depicted in FIG. 2, and a person having ordinary skill in the art will appreciate that such communication means are within the scope of the present disclosure.

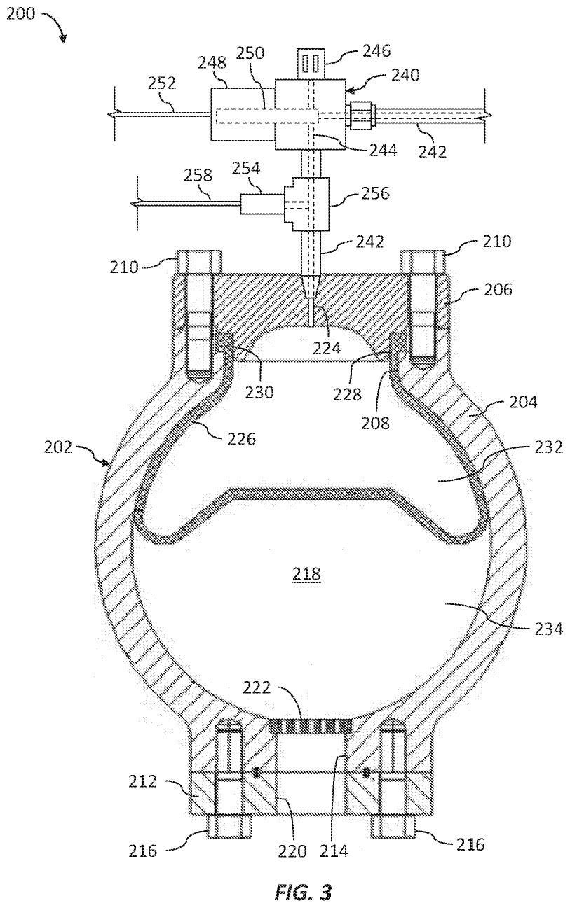

FIG. 3 is an example implementation of at least a portion of a pressure pulsation dampening system 200 operable to dissipate or otherwise reduce magnitude of the pressure pulsations (i.e., spikes) in a pumped fluid according to one or more aspects of the present disclosure. The dampening system 200 may comprise a pulsation dampener 202 having a housing (i.e., a pressure vessel) that includes a body 204, an upper cap 206 fixedly connected over an upper opening 208 of the body 204 via a plurality of threaded bolts 210, and a lower cap 212 fixedly connected at a lower opening 214 of the body 204 via a plurality of threaded bolts 216. The body 204, the upper cap 206, and/or the lower cap 212 may collectively define an internal gas chamber 218 operable to contain pressurized gas. The lower cap 210 may comprise a fluid port 220 (i.e., inlet and outlet) aligned with the lower opening 214, such as may be utilized to fluidly connect the chamber 218 with or along a fluid discharge line of a pump (e.g., pump 128 shown in FIG. 2). The pulsation dampener 202 may further comprise a net or sieve 222, such as may be operable to prevent particulate matter and contaminants from entering the chamber 218. The upper cap 206 may comprise a gas port 224 (i.e., inlet and outlet) fluidly connected with the chamber 218. The pulsation dampener 202 may further comprise a flexible gas bladder 226 (e.g., membrane, diaphragm, bag, flex tube, etc.) disposed within the chamber 218. The gas bladder 226 comprises an opening 228 defined by a rim 230 clamped or otherwise compressed between the body and the upper cap 206 to connect the gas bladder 226 with the housing 204 such that the opening 228 of the bladder 226 and the opening 208 of the body 204 are aligned. Accordingly, the gas bladder 226 defines an internal volume 232 of the chamber 218 fluidly connected with the gas inlet 222. The internal volume 232 may be fluidly isolated from an external volume 234 of the chamber 218 located externally from the bladder 226 and fluidly connected with the fluid port 220.

The dampening system 200 may further comprise a pressure regulator 240 fluidly connected with or along a gas charge line 242 extending between a source of gas (e.g., the compressor 134 and/or the nitrogen generator 136 shown in FIG. 2) and the internal volume 232 of the bladder 226. The gas charge line 242 may comprise one or more fluid conduits, fluid connectors, and fluid fittings collectively operable to fluidly connect the gas source with the bladder 226 via the gas port 224. The pressure regulator 240 may be remotely operable to modulate or otherwise adjust pressure within the internal volume 232. For example, the pressure regulator 240 may be selectively operated to permit gas to flow through internal pathways 244 of the pressure regulator 240 from the gas source into the internal volume 232 to increase the gas pressure within the internal volume 232. The pressure regulator 240 may be further selectively operated to permit the gas to flow through the internal pathways 244 from the internal volume 232 to be relieved to the atmosphere via a gas vent 246 and, thus, decrease the gas pressure within the internal volume 232. The pressure regulator 240 may be a remotely operated, such as via an electrically operated magnetic coil 248. The magnetic coil 248 may selectively actuate an internal fluid control member 250 (e.g., a spool, a plunger, a plug, a diaphragm, etc.) based on an electrical signal from a controller (e.g., the controller 150 shown in FIG. 2) to selectively control gas flow through the internal pathways 244 of the pressure regulator 240 and, thus, adjust the gas pressure within the internal volume 232 of the pulsation dampener 202 to an intended level. The pressure regulator 240 may progressively adjust the gas pressure, such as based on voltage applied to the magnetic coil 248. The magnetic coil 248 may be communicatively connected with the controller via an electrical conductor 252.

The dampening system 200 may also comprise a pressure sensor 254 fluidly connected with the internal volume 232 of the bladder 226 and operable to generate electrical signals or information indicative of gas pressure within the internal volume 232. The pressure sensor 254 may be fluidly connected with or along the gas charge line 242 between the pressure regulator 240 and the gas port 224, and in close proximity with the gas port 224. The pressure sensor 254 may be fluidly connected with the gas charge line 242 via a fluid connector 256, such as a tee connector. The pressure sensor 254 may be communicatively connected with the controller via an electrical conductor 258.

Although FIGS. 2 and 3 show the pulsation dampening systems 120, 200, respectively, comprising pulsation dampeners 122, 202 having a bladder 124, 226, it is to be understood that pulsation dampening systems within the scope of the present disclosure may comprise or utilize pulsation dampeners that do not include a bladder or similar member (e.g., bladderless pulsation dampeners) to fluidly isolate the pulsating fluid (e.g., liquid) from the pressurized gas within the pulsation dampener.

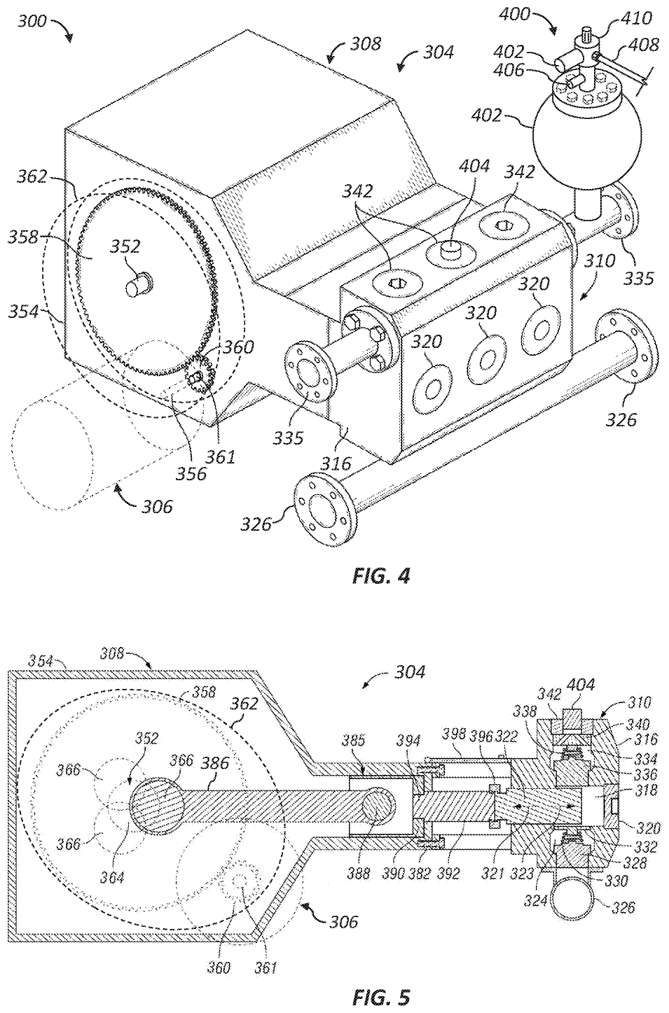

FIGS. 4 and 5 are perspective and side sectional views, respectively, of at least a portion of an example implementation of a pump unit 300 with which a pressure pulsation dampening system 400 according to one or more aspects of the present disclosure may be utilized. The dampening system 400 may comprise one or more features of the dampening systems 100, 120, 200 described above and shown in FIGS. 1-3. Portions of the pump unit 300 shown in FIGS. 4 and 5 are shown in phantom lines, such as to prevent obstructing from view other portions of the pump unit 300. The following description refers to FIGS. 4 and 5, collectively.

The pump unit 300 may be utilized at an oil and gas wellsite to move fluids between different wellsite equipment and/or to inject fluids into a wellbore. In an example implementation, the pump unit 300 may be utilized to pump drilling fluid into and through a drill string during drilling operations. The pump unit 300 may also or instead be utilized to inject fracturing fluid into the wellbore during hydraulic fracturing operations. The pump unit 300 may also or instead be utilized to pump or inject other fluids into the wellbore, such as during cementing, acidizing, chemical injecting, and/or water jet cutting operations, among other examples. Accordingly, unless described otherwise, the one or more fluids being pumped by the pump unit 300, may be referred to hereinafter simply as “a fluid.”

The pump unit 300 comprises a pump 304 operatively coupled with and actuated by a prime mover 306. The pump 304 includes a power section 308 and a fluid section 310. The fluid section 310 may comprise a pump housing 316 having a plurality of fluid chambers 318. One end of each fluid chamber 318 may be plugged by a cover plate 320, such as may be threadedly engaged with the pump housing 316 and an opposite end of each fluid chamber 318 may contain a reciprocating member 322 slidably disposed therein and operable to displace the fluid within the corresponding fluid chamber 318. Although the reciprocating member 322 is depicted as a plunger, the reciprocating member 322 may also be implemented as a piston, diaphragm, or another reciprocating fluid displacing member.

Each fluid chamber 318 is fluidly connected with a corresponding one of a plurality of fluid inlet cavities 324 each adapted for communicating fluid from fluid inlets 326 into a corresponding fluid chamber 318. One or both of the fluid inlets 326 may be connected with fluid conduit(s) that are fluidly connected with a source of fluid (e.g., a fluid blender). Each fluid inlet cavity 324 may contain an inlet valve 328 operable to control fluid flow from the fluid inlets 326 into the fluid chamber 318. Each inlet valve 328 may be biased toward a closed flow position by a first spring or another biasing member 330, which may be held in place by an inlet valve stop 332. Each inlet valve 328 may be actuated to an open flow position by a predetermined differential pressure between the corresponding fluid inlet cavity 324 and the fluid inlets 326.

Each fluid chamber 318 is also fluidly connected with a fluid outlet cavity 334 extending through the pump housing 316 transverse to the reciprocating members 322. The fluid outlet cavity 334 is adapted for communicating pressurized fluid from each fluid chamber 318 into one or more fluid outlets 335 fluidly connected at one or both ends of the fluid outlet cavity 334. The fluid outlets 335 may be connected with a fluid discharge line (e.g., discharge line 126 shown in FIG. 2). The fluid section 310 also contains a plurality of outlet valves 336 each operable to control fluid flow from a corresponding fluid chamber 318 into the fluid outlet cavity 334. Each outlet valve 336 may be biased toward a closed flow position by a spring or another biasing member 338, which may be held in place by an outlet valve stop 340. Each outlet valve 336 may be actuated to an open flow position by a predetermined differential pressure between the corresponding fluid chamber 318 and the fluid outlet cavity 334. The fluid outlet cavity 334 may be plugged by cover plates 342, such as may be threadedly engaged with the pump housing 316.

During pumping operations, portions of the power section 308 of the pump unit 300 rotate in a manner that generates a reciprocating linear motion to move the reciprocating members 322 longitudinally within the corresponding fluid chambers 318, thereby alternatingly drawing and displacing the fluid within the fluid chambers 318. With regard to each reciprocating member 322, while the reciprocating member 322 moves out of the fluid chamber 318, as indicated by arrow 321, the pressure of the fluid inside the corresponding fluid chamber 318 decreases, thus creating a differential pressure across the corresponding fluid inlet valve 328. The pressure differential operates to compress the biasing member 330, thus actuating the fluid inlet valve 328 to an open flow position to permit the fluid from the fluid inlets 326 to enter the corresponding fluid inlet cavity 324. The fluid then enters the fluid chamber 318 while the reciprocating member 322 continues to move longitudinally out of the fluid chamber 318 until the pressure difference between the fluid inside the fluid chamber 318 and the fluid at the fluid inlets 326 is low enough to permit the biasing member 330 to actuate the fluid inlet valve 328 to the closed flow position. When the reciprocating member 322 begins to move longitudinally back into the fluid chamber 318, as indicated by arrow 323, the pressure of the fluid inside of fluid chamber 318 begins to increase. The fluid pressure inside the fluid chamber 318 continues to increase as the reciprocating member 322 continues to move into the fluid chamber 318 until the pressure of the fluid inside the fluid chamber 318 is high enough to overcome the pressure of the fluid inside the fluid outlet cavity 334 and compress the biasing member 338, thus actuating the fluid outlet valve 336 to the open flow position and permitting the pressurized fluid to move into the fluid outlet cavity 334, the fluid outlets 335, and the discharge line.

The fluid flow rate generated by the pump unit 300 may depend on the physical size of the reciprocating members 322 and fluid chambers 318, as well as the pump unit operating speed, which may be defined by the speed or rate at which the reciprocating members 322 cycle or move within the fluid chambers 318. The pumping speed, such as the speed or the rate at which the reciprocating members 322 move, may be related to the rotational speed of the power section 308 and/or the prime mover 306. Accordingly, the fluid flow rate generated by the pump unit 300 may be controlled by controlling the rotational speed of the power section 308 and/or the prime mover 306.

The prime mover 306 may comprise an engine, such as a gasoline engine or a diesel engine, an electric motor, such as a synchronous or asynchronous electric motor, including a synchronous permanent magnet motor, a hydraulic motor, or another prime mover operable to drive or otherwise rotate a drive shaft 352 of the power section 308. The drive shaft 352 may be enclosed and maintained in position by a power section housing 354. To prevent relative rotation between the power section housing 354 and the prime mover 306, the power section housing 354 and prime mover 306 may be fixedly coupled together or to a common base, such as a skid (not shown).

The prime mover 306 may comprise a rotatable output shaft 356 operatively connected with the drive shaft 352 via a gear train or transmission 362, which may comprise a spur gear 358 coupled with the drive shaft 352 and a corresponding pinion gear 360 coupled with a support shaft 361. The output shaft 356 and the support shaft 361 may be coupled, such as may facilitate transfer of torque from the prime mover 306 to the support shaft 361, the pinion gear 360, the spur gear 358, and the drive shaft 352. For clarity, FIGS. 4 and 5 show the transmission 362 comprising a single spur gear 358 engaging a single pinion gear 360, however, it is to be understood that the transmission 362 comprises a plurality of corresponding sets of gears, such as may permit the transmission 362 to be shifted between different gear sets (i.e., combinations) to control the operating speed of the drive shaft 352 and torque transferred to the drive shaft 352. Accordingly, the transmission 362 may be shifted between different gear sets (“gears”) to vary the pumping speed and torque of the power section 308 to vary the fluid flow rate and maximum fluid pressure generated by the fluid section 310 of the pump unit 300.

The drive shaft 352 may be implemented as a crankshaft comprising a plurality of axial journals 364 and offset journals 366. The axial journals 364 may extend along a central axis of rotation of the drive shaft 352, and the offset journals 366 may be offset from the central axis of rotation by a distance and spaced 120 degrees apart with respect to the axial journals 364. The drive shaft 352 may be supported in position within the power section 308 by the power section housing 354, wherein two of the axial journals 364 may extend through opposing openings in the power section housing 354.

The power section 308 and the fluid section 310 may be coupled or otherwise connected together. For example, the pump housing 316 may be fastened with the power section housing 354 by a plurality of threaded fasteners 382. The pump 304 may further comprise an access door 398, which may facilitate access to portions of the pump 304 located between the power section 308 and the fluid section 310, such as during assembly and/or maintenance of the pump 304.

To transform and transmit the rotational motion of the drive shaft 352 to a reciprocating linear motion of the reciprocating members 322, a plurality of crosshead mechanisms 385 may be utilized. For example, each crosshead mechanism 385 may comprise a connecting rod 386 pivotally coupled with a corresponding offset journal 366 at one end and with a pin 388 of a crosshead 390 at an opposing end. During pumping operations, walls and/or interior portions of the power section housing 354 may guide each crosshead 390, such as may prevent or inhibit lateral motion of each crosshead 390. Each crosshead mechanism 385 may further comprise a piston rod 392 coupling the crosshead 390 with the reciprocating member 322. The piston rod 392 may be coupled with the crosshead 390 via a threaded connection 394 and with the reciprocating member 322 via a flexible connection 396.

The dampening system 400 may comprise a gas-charged pressure pulsation dampener 402, which may be fluidly connected with or along one or both of the fluid outlets 335 of the pump 304 via a fluid port (obstructed from view) of the pulsation dampener 402. The pulsation dampener 402 may comprise one or more features of the pulsation dampeners 122, 202 described above and shown in FIGS. 2 and 3, respectively. The dampening system 400 may further comprise a pressure sensor 404 operable to generate electrical signals or information indicative of fluid pressure at the fluid outlets 335. The pressure sensor 404 may be fluidly connected in association with the fluid section 310 in a manner permitting the sensing of fluid pressure at the fluid outlets 335 and, thus, the pulsation dampener 402. For example, the pressure sensor 404 may extend through one or more of the cover plates 342 or other portions of the corresponding pump housing 316 to monitor pressure within the fluid outlet cavity 334 and, thus, the fluid outlets 335.

The dampening system 400 may further comprise a gas source (e.g., gas compressor 134 and/or nitrogen generator 136 shown in FIG. 2) for supplying pressurized gas to the pulsation dampener 402. A gas charge line 408 may extend between the gas source and a gas port (obstructed from view) of the pulsation dampener 402 to fluidly connected the gas source with the pulsation dampener 402.

The gas pressure within the pulsation dampener 402 may be modulated via a pressure regulator 410 (e.g., a pressure modulator) fluidly connected with the pulsation dampener 402. The pressure regulator 410 may comprise one or more features of the pressure regulators 110, 144, 240 described above and shown in FIGS. 1, 2, and 3, respectively. The pressure regulator 410 may be fluidly connected with or along the gas charge line 408 between the pulsation dampener 402 and the gas source. The pressure regulator 410 may be a remotely operated, such as via an electrically operated magnetic coil 412, which may actuate the pressure regulator 410 to modulate or otherwise change downstream pressure and, thus, gas charge pressure within the pulsation dampener 402 to an intended level. The dampening system 400 may also comprise a pressure sensor 406 operable to generate electrical signals or information indicative of gas pressure within the pulsation dampener 402. The pressure sensor 406 may be connected with or along the gas charge line 408 between the pulsation dampener 402 and the pressure regulator 410, such as may permit the pressure sensor 406 to monitor gas pressure within the pulsation dampener 402.

During pumping operations, the pulsation dampener 402 may be in fluid communication with the fluid discharged via the fluid outlets 335, such that the discharged fluid partially enters the pulsation dampener 402 cyclically compressing the pressurized gas within the pulsation dampener 402, perhaps within a bladder. The cyclic gas compression dampens, dissipates, or otherwise reduce magnitude of the pressure pulsations within the discharged fluid downstream from the pulsation dampener 402. The signals or information generated by the pressure sensors 404, 406 may be transmitted to a controller (e.g., controller 112, 150 shown in FIGS. 1 and 2, respectively), which may receive and process the signals or information and transmit corresponding control signals to the pressure regulator 410 to control the gas charge pressure within the pulsation dampener 402 based on the fluid pressure at the pump outlets 335 and a program code or otherwise in a predetermined manner as described herein. The controller may automatically and in real-time cause the pressure regulator 410 to change the gas charge pressure to an intended level with respect to the fluid pressure (e.g., moving RMS average pressure) discharged by the pump 304 while such fluid pressure changes.

Although FIGS. 4 and 5 show the pulsation dampening system 400 connected and utilized with the pump unit 300 comprising a triplex reciprocating pump 304, a pulsation dampening system according to one or more aspects of the present disclosure may form a portion of, be fluidly connected with, or otherwise be utilized with other pumps producing unintended pressure pulsations or spikes during pumping operations. The pulsation dampening system may be utilized, for example, with a quintuplex reciprocating pump having five fluid chambers 318 and five reciprocating members 322, or a pump having other quantities of fluid chambers 318 and reciprocating members 322. The pulsation dampening system may be utilized with other pumps, such as diaphragm pumps, gear pumps, external circumferential pumps, internal circumferential pumps, lobe pumps, and other pumps that produce unintended pressure pulsations or spikes.

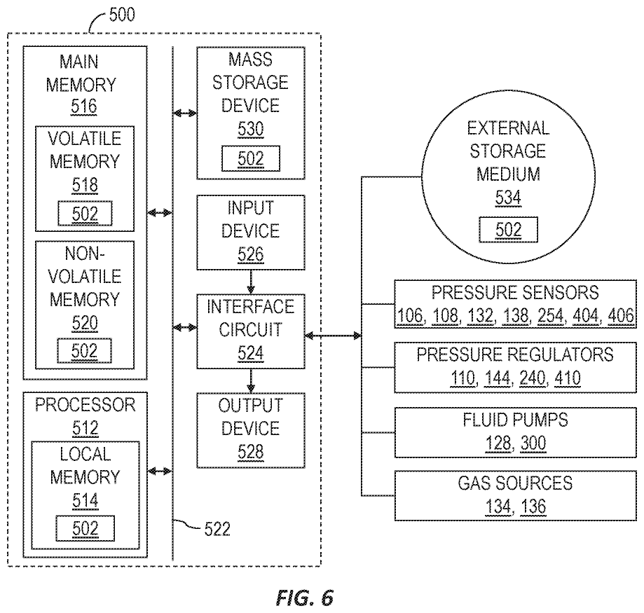

FIG. 6 is a schematic view of at least a portion of an example implementation of a processing device 500 according to one or more aspects of the present disclosure. The processing device 500 may form at least a portion of one or more electronic devices described herein. For example, the processing device 500 may be or form at least a portion of the controllers 112, 150, a control workstation, a control center, and/or other control devices at a wellsite.

The processing device 500 may be communicatively connected with various sensors (e.g., pressure sensors 106, 108, 132, 138, 254, 406), actuators (e.g., pressure regulators 110, 144, 240, 410), local controllers, and other devices within the scope of the present disclosure. The processing device 500 may be communicatively connected with the fluid pumps 128, 300 and/or the gas sources 134, 136. For clarity, these and other components in communication with the processing device 500 will be referred to hereinafter as “sensors” and/or “actuators.” Accordingly, the following description refers to FIGS. 1-6, collectively.

The processing device 500 may be operable to receive coded instructions 502 from equipment operators and sensor signals or information generated by the sensors, process the coded instructions 502 and sensor information, and communicate control signals or information to the actuators to execute the coded instructions 502 to implement at least a portion of one or more example methods and/or operations described herein, and/or to implement at least a portion of one or more of the example systems described herein.

The processing device 500 may be or comprise, for example, one or more processors, special-purpose computing devices, servers, personal computers (e.g., desktop, laptop, and/or tablet computers), personal digital assistants, smartphones, internet appliances, and/or other types of computing devices. The processing device 500 may comprise a processor 512, such as a general-purpose programmable processor. The processor 512 may comprise a local memory 514, and may execute coded instructions 502 present in the local memory 514 and/or another memory device. The processor 512 may execute, among other things, the machine-readable coded instructions 502 and/or other instructions and/or programs to implement the example methods and/or operations described herein. The coded instructions 502 stored in the local memory 514 may include program instructions or computer program code that, when executed by the processor 512 of the processing device 500, may cause the actuators to perform the example methods and/or operations described herein. The processor 512 may be, comprise, or be implemented by one or more processors of various types suitable to the local application environment, and may include one or more of general-purpose computers, special-purpose computers, microprocessors, digital signal processors (DSPs), field-programmable gate arrays (FPGAs), application-specific integrated circuits (ASICs), and processors based on a multi-core processor architecture, as non-limiting examples. Of course, other processors from other families are also appropriate.

The processor 512 may be in communication with a main memory 516, such as may include a volatile memory 518 and a non-volatile memory 520, perhaps via a bus 522 and/or other communication means. The volatile memory 518 may be, comprise, or be implemented by random access memory (RAM), static random access memory (SRAM), synchronous dynamic random access memory (SDRAM), dynamic random access memory (DRAM), RAMBUS dynamic random access memory (RDRAM), and/or other types of random access memory devices. The non-volatile memory 520 may be, comprise, or be implemented by read-only memory, flash memory, and/or other types of memory devices. One or more memory controllers (not shown) may control access to the volatile memory 518 and/or non-volatile memory 520.

The processing device 500 may also comprise an interface circuit 524. The interface circuit 524 may be, comprise, or be implemented by various types of standard interfaces, such as an Ethernet interface, a universal serial bus (USB), a third generation input/output (3GIO) interface, a wireless interface, a cellular interface, and/or a satellite interface, among others. The interface circuit 524 may also comprise a graphics driver card. The interface circuit 524 may also comprise a communication device, such as a modem or network interface card to facilitate exchange of data with external computing devices via a network (e.g., Ethernet connection, digital subscriber line (DSL), telephone line, coaxial cable, cellular telephone system, satellite, etc.). One or more of the sensors and the actuators may be connected with the processing device 500 via the interface circuit 524, such as may facilitate communication between the processing device 500 and the sensors and/or the actuators.

One or more input devices 526 may also be connected to the interface circuit 524. The input devices 526 may permit the equipment operators to enter the coded instructions 502, such as program code, control commands, processing routines, operational settings and set-points, including program code to determine average pumping pressure (e.g., RMS average pressure, moving average pressure) of the pump 128, 300 and program code setting intended pressure relationship between the average pumping pressure and the gas charge pressure of the pulsation dampener 122, 202, 402. The input devices 526 may be, comprise, or be implemented by a keyboard, a mouse, a joystick, a touchscreen, a track-pad, a trackball, an isopoint, and/or a voice recognition system, among other examples. One or more output devices 528 may also be connected to the interface circuit 524. The output devices 528 may be, comprise, or be implemented by video output devices (e.g., an LCD, an LED display, a CRT display, a touchscreen, etc.), printers, and/or speakers, among other examples. The processing device 500 may also communicate with one or more mass storage devices 530 and/or a removable storage medium 534, such as may be or include floppy disk drives, hard drive disks, compact disk (CD) drives, digital versatile disk (DVD) drives, and/or USB and/or other flash drives, among other examples.

The coded instructions 502 may be stored in the mass storage device 530, the main memory 516, the local memory 514, and/or the removable storage medium 534. Thus, the processing device 500 may be implemented in accordance with hardware (perhaps implemented in one or more chips including an integrated circuit, such as an ASIC), or may be implemented as software or firmware for execution by the processor 512. In the case of firmware or software, the implementation may be provided as a computer program product including a non-transitory, computer-readable medium or storage structure embodying computer program code (i.e., software or firmware) thereon for execution by the processor 512. The coded instructions 502 may include program instructions or computer program code that, when executed by the processor 512, may cause the actuators and other equipment to perform intended methods, processes, and/or operations disclosed herein.

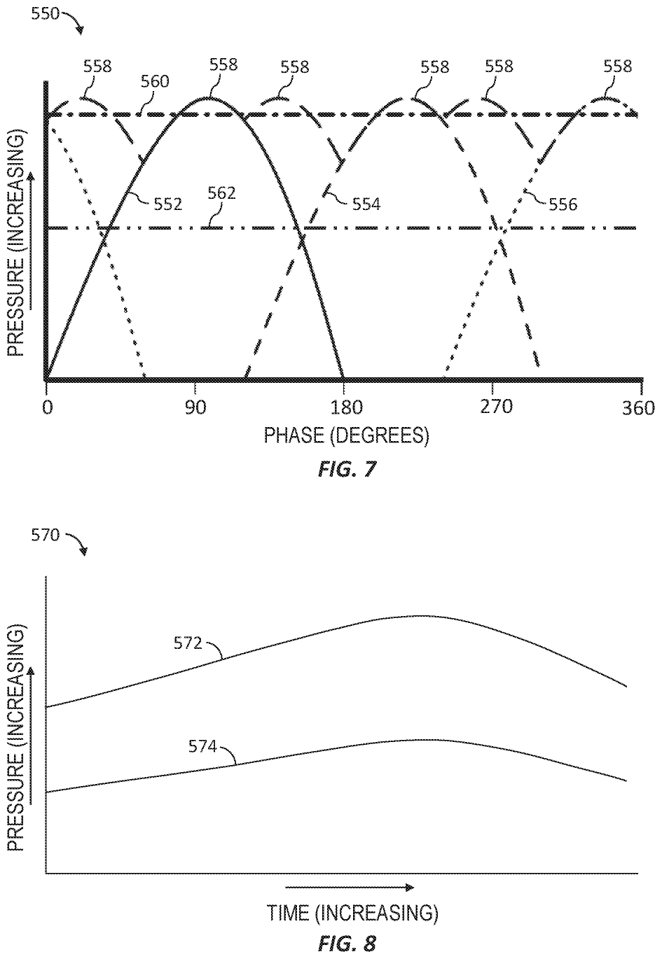

FIG. 7 is a graph 550 showing a portion of an example pressure pulsation profile of a fluid pumped by a pump fluidly connected with or otherwise utilized in association with a pressure pulsation dampening system within the scope of the present disclosure (e.g., pressure pulsation dampening systems 100, 120, 200, 400). The graph 550 shows an example relationship between pump discharge pressure, plotted along the vertical axis, and pump operational phase (i.e., rotational position) of the pump, plotted along the horizontal axis. The graph 550 shows an operating pressure profile of a triplex pump (e.g., pump 304) comprising three reciprocating members, each forming a corresponding pressure fluctuation 552, 554, 556 every 120 degree interval and collectively forming six pressure spikes 558 (e.g., pulsations, peaks, etc.) every 360 degree rotation of the pump. Although the graph 550 shows a pressure profile of a rotary triplex pump, it is to be understood that the pressure pulsation dampening system of the present disclosure may be fluidly connected to or otherwise utilized with a quintuplex pump having five reciprocating members or other pumps generating unintended pressure spikes.

A controller (e.g., controller 112, 150, 500) of the pressure pulsation dampening system may be operable to calculate or otherwise determine an average pressure 560 (e.g., RMS average, moving average) of the pulsating fluid discharged by the pump based on signals or information generated by a pressure g (e.g., pressure sensor 106, 132, 404) and calculate or otherwise determine a target gas charge pressure 562 of a pulsation dampener (e.g., pulsation dampener 122, 202, 402) of the pressure pulsation dampening system based on signals or information generated by a pressure sensor (e.g., pressure sensor 108, 138, 254, 406). The controller may modulate or otherwise change the target gas charge pressure 562 in real-time to an intended target level with respect to the determined average pressure 560 via a pressure regulator (e.g., pressure regulator 110, 144, 240, 410) or other means while the average pressure 560 changes during pumping operations.

The controller may be further operable to perform a test of the determined target charge pressure 562 by incrementally or otherwise progressively changing (i.e., increasing or decreasing) the determined target charge pressure 562 by a predetermined amount (e.g., +/−10 PSI, +/−25 PSI, +/−50 PSI, +/−100 PSI, +/−250 PSI) or percentage (e.g., +/−0.5%, +/−1%, +/−2%, +/−3%, +/−5%, +/−10%) while monitoring magnitude of pressure pulsations (i.e., monitoring signals or information generated by the pressure sensor) for net changes (i.e., increases and decreases) until an optimum target charge pressure 562 that causes the fluid to contain the smallest pressure pulsations is reached or otherwise found. If decrease in pressure pulsations is detected, the test may be repeated (e.g., by using smaller pressure change increments) to home in on an optimum target charge pressure 562. If no decrease in magnitude of pressure pulsations is detected, the controller may reset the target charge pressure 562 to the originally determined level and incrementally or otherwise progressively change the determined target charge pressure 562 by a predetermined amount or percentage on an opposing side of such determined target charge pressure 562 while monitoring magnitude of pressure pulsations for net changes. The predetermined amount or percentage by and/or to which the determined target charge pressure 562 may be incrementally or otherwise progressively changed may also or instead be determined based on wellsite operator field experience.

As described herein, fluid pumps at an oil and gas wellsite may operate at average pressures that change during a job or between stages of pumping operations. For example, during drilling operations, drilling fluid pumps may pump drilling fluid at a pressure the continually increases with wellbore depth. FIG. 8 is a graph 570 showing an example pressure profile 572 of a fluid being pumped downhole and an example pressure profile 574 of a gas within a pulsation dampener, with respect to time. The profile 572 shows an average operating pressure (e.g., RMS average, moving average) of a fluid pump fluidly connected with or otherwise utilized in association with a pressure pulsation dampening system and the profile 574 shows a gas charge pressure of a pulsation dampener of the pressure pulsation dampening system. The pressures 572, 574, plotted along the vertical axis, increase and then decrease with respect to time, plotted along the horizontal axis.

During pumping operations, a controller may monitor the gas charge pressure 574 within a pulsation dampener, and modulate or otherwise adjust such gas charge pressure 574 in real-time based on the changing average pressure 572 of the fluid discharged by the pump. For example, the controller may cause increase and decrease of the gas charge pressure 574 while the average pressure 572 increases and decreases, such as to maintain the gas charge pressure 574 at about 50% of the discharged fluid pressure 572. Although the gas charge pressure 574 is set to be maintained at about 50% of the average discharged fluid pressure 572, it is to be understood that a pressure pulsation dampening system within the scope of the present disclosure may be set to maintain the gas charge pressure of a pulsation dampener at other relative levels with respect to an average fluid pump operating pressure. For example, a gas charge pressure may be maintained at 40% of an average fluid pump operating pressure or a gas charge pressure may be maintained at 90% of an average fluid pump operating pressure.

Furthermore, instead of the dampening system modulating gas charge pressure within the pulsation dampener continually during pumping operations, a pressure pulsation dampening system within the scope of the present disclosure may be operable to adjust the gas charge pressure within the pulsation dampener between stages or phases of pumping operations, such as when the pumping operations have been momentarily stopped. Furthermore, the gas charge pressure within the pulsation dampener may be adjusted to an optimal gas charge pressure determined by the controller executing a program code (e.g., optimization algorithm) and based on average pressure trends or pressure readings collected during the previous one or more stages of the pumping operations. For example, during drilling operations, the gas charge pressure within the pulsation dampener may be adjusted during successive drill pipe connections at which times the drilling fluid is not being pumped by the pump. An optimal gas charge pressure within the pulsation dampener may be determined by the controller executing a program code and based on average pressure trends or pressure readings collected during the previous one or more stages of the drilling operations.

In view of the entirety of the present disclosure, including the figures and the claims, a person having ordinary skill in the art will readily recognize that the present disclosure introduces an apparatus comprising a system for reducing magnitude of pressure pulsations within a fluid, wherein the system comprises: a source of a gas; a pulsation dampener fluidly connected with the gas source and with the fluid containing the pressure pulsations; a pressure sensor operable to generate signals or information indicative of fluid pressure of the fluid containing the pressure pulsations; and a pressure regulator operable to control gas pressure of the gas within the pulsation dampener based on the fluid pressure.

The fluid may be a process fluid configured for injection into a wellbore.

The fluid may be a drilling fluid configured for injection into a wellbore via a drill string.

The gas source may be or comprise a nitrogen generator.

The fluid containing the pressure pulsations may be transmitted through a fluid conduit, and the pulsation dampener may be fluidly connected along the fluid conduit. The fluid conduit may form at least a portion of, or may be fluidly connected with, an outlet of a fluid pump, and the pressure pulsations within the fluid may be generated by the fluid pump. The pressure sensor may be connected in association with the fluid pump, and the signals or information generated by the pressure sensor may be indicative of operating pressure of the fluid pump.

The pressure sensor may be a first pressure sensor, and the system may comprise a second pressure sensor operable to generate signals or information indicative of the gas pressure within the pulsation dampener. The second pressure sensor may be fluidly connected between the pressure regulator and the pulsation dampener.

The pulsation dampener may comprise a chamber, a first port fluidly connected with the gas source, and a second port fluidly connected with the fluid. The pulsation dampener may comprise a flexible bladder disposed within the chamber and fluidly isolating the first and second ports from each other.

The pressure regulator may be fluidly connected between the gas source and the pulsation dampener, and the pressure regulator may be operable to control the gas pressure within the pulsation dampener by selectively: transmitting the gas from the gas source into the pulsation dampener; and relieving the gas out of the pulsation dampener.

The pressure regulator may be operable to automatically maintain the gas pressure within the pulsation dampener at an intended gas pressure with respect to the fluid pressure while the fluid pressure changes. The pressure regulator may be further operable to automatically incrementally change the intended gas pressure within the pulsation dampener until an optimal gas pressure within the pulsation dampener that causes the fluid to contain smallest pressure pulsations is reached.

The system may comprise or be communicatively connected to a controller comprising a processor and a memory operable to store a computer program code, and the controller may be operable to: receive the signals or information indicative of the fluid pressure; and generate control signals or information for controlling the pressure regulator to control the gas pressure within the pulsation dampener to an intended gas pressure, wherein the control signals or information for controlling the pressure regulator may be based on the received signals or information indicative of fluid pressure and the computer program code. The controller may be operable to determine an average fluid pressure based on the received signals or information indicative of fluid pressure, and the control signals or information for controlling the pressure regulator may be based on the determined average fluid pressure.

The pressure sensor may be a first pressure sensor, the system may comprise a second pressure sensor operable to generate signals or information indicative of the gas pressure within the pulsation dampener, the system may comprise or be communicatively connected to a controller comprising a processor and a memory operable to store a computer program code, and the first pressure sensor, the second pressure sensor, and the pressure regulator may be communicatively connected with the controller. The processor may be operable to: receive the signals or information indicative of fluid and gas pressures; and generate control signals or information for controlling the pressure regulator to change the gas pressure within the pulsation dampener to an intended gas pressure, wherein the control signals or information for controlling the pressure regulator may be based on the received signals or information indicative of fluid and gas pressures and the computer program code.

The present disclosure also introduces an apparatus comprising a system for reducing magnitude of pressure pulsations within a fluid, wherein the system comprises: a gas source; a pulsation dampener fluidly connected with the gas source and along a fluid conduit transmitting the fluid containing the pressure pulsations; a first pressure sensor operable to generate signals or information indicative of pressure of the fluid containing the pressure pulsations; a second pressure sensor operable to generate signals or information indicative of pressure of gas within the pulsation dampener; and a pressure modulator operable to automatically modulate the gas pressure within the pulsation dampener based on the fluid pressure while the fluid pressure changes.

The fluid may be a process fluid for injection into a wellbore.

The fluid may be a drilling fluid for injection into a wellbore via a drill string.

The gas source may be or comprise a nitrogen generator.

The fluid conduit may form at least a portion of, or may be fluidly connected with, an outlet of a fluid pump, and the pressure pulsations within the fluid may be generated by the fluid pump. The first pressure sensor may be connected in association with the fluid pump, and the signals or information generated by the first pressure sensor may be indicative of operating pressure of the fluid pump.

The second pressure sensor may be fluidly connected between the pressure modulator and the pulsation dampener.

The pulsation dampener may comprise: a chamber; a first port fluidly connected with the gas source; and a second port fluidly connected with the fluid conduit. The pulsation dampener may further comprise a flexible bladder disposed within the chamber and fluidly isolating the first and second ports from each other.

The fluid pressure may be an average fluid pressure, and the pressure modulator may be operable to automatically maintain the gas pressure within the pulsation dampener at an intended gas pressure with respect to the average fluid pressure while the average fluid pressure changes.

The pressure modulator may be fluidly connected between the gas source and the pulsation dampener, and the pressure modulator may be operable to modulate the gas pressure within the pulsation dampener by selectively: transmitting the gas from the gas source into the pulsation dampener; and relieving the gas out of the pulsation dampener.

The system may comprise or be communicatively connected to a controller comprising a processor and a memory operable to store a computer program code, and the controller may be operable to: receive the signals or information indicative of fluid pressure; receive the signals or information indicative of gas pressure; and generate control signals or information for controlling the pressure modulator to modulate the gas pressure within the pulsation dampener to an intended gas pressure, wherein the control signals or information for controlling the pressure modulator may be based on the received signals or information indicative of fluid and gas pressures and on the computer program code. The controller may be operable to determine an average fluid pressure based on the received signals or information indicative of fluid pressure, and the control signals or information for controlling the pressure modulator may be based on the determined average fluid pressure.

The present disclosure also introduces a method comprising reducing magnitude of pressure pulsations within a fluid via a pulsation dampener while automatically changing pressure of a gas within the pulsation dampener to an intended gas pressure with respect to pressure of the fluid while the pressure of the fluid changes.

The fluid may be a process fluid being injected into a wellbore.

The fluid may be a drilling fluid being injected into a wellbore via a drill string.

The gas may be or comprise nitrogen.

Automatically changing the pressure of the gas within the pulsation dampener may comprise selectively: transmitting the gas into the pulsation dampener; and relieving the gas out of the pulsation dampener.

Automatically changing the pressure of the gas within the pulsation dampener may comprise remotely operating a pressure modulator fluidly connected with a chamber of the pulsation dampener.

The method may comprise monitoring pressure of the gas within the pulsation dampener.

The method may comprise determining an average pressure of the fluid based on the pressure of the fluid containing the pressure pulsations, wherein the intended gas pressure of the gas within the pulsation dampener may be automatically changed with respect to the average pressure of the fluid while the average pressure of the fluid changes.

The method may comprise automatically incrementally changing the intended gas pressure of the gas within the pulsation dampener until an optimal gas pressure of the gas within the pulsation dampener that causes smallest magnitude of the pressure pulsations is found.

The pressure pulsations within the fluid may be generated by a fluid pump.

The method may comprise fluidly connecting a gas port of the pulsation dampener with a source of the gas and fluidly connecting a fluid port of the pulsation dampener with a source of the fluid containing the pressure pulsations. The pulsation dampener may further comprise a flexible bladder disposed within the chamber and fluidly isolating the gas and fluid ports from each other.

The method may comprise operating a controller comprising a processor and a memory for storing a computer program code, wherein operating the controller may comprise, while the pressure of the fluid changes: receiving from a pressure sensor signals or information indicative of the pressure of the fluid; and generating control signals or information for controlling a pressure modulator based on the computer program code and the received signals or information indicative of the pressure of the fluid to automatically change the pressure of the gas within the pulsation dampener to the intended gas pressure with respect to the pressure of the fluid. The method may comprise operating the controller to determine an average pressure of the fluid based on the received signals or information indicative of the pressure of the fluid, and the generated control signals or information for controlling the pressure modulator may be based on the determined average pressure of the fluid. The pressure sensor may be a first pressure sensor, operating the controller may comprise receiving from a second pressure sensor signals or information indicative of the pressure of the gas within the pulsation dampener, and the generated control signals or information for controlling the pressure modulator may be further based on the received signals or information indicative of the pressure of the gas within the pulsation dampener.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the scope of the present disclosure, and that they may make various changes, substitutions and alterations herein without departing from the spirit and scope of the present disclosure.

The Abstract at the end of this disclosure is provided to allow the reader to quickly ascertain the nature of the technical disclosure. It is submitted with the understanding that it will not be used to interpret or limit the scope or meaning of the claims.

What is claimed is:

1. An apparatus comprising:
a system for reducing magnitude of pressure pulsations within a fluid, wherein the system comprises:
a source of a gas;
a pulsation dampener fluidly connected with the gas source and with the fluid containing the pressure pulsations;
a pressure sensor operable to generate signals or information indicative of fluid pressure of the fluid containing the pressure pulsations; and
a pressure regulator operable to control gas pressure of the gas within the pulsation dampener based on the fluid pressure.

2. The apparatus of claim 1 wherein the fluid is a drilling fluid configured for injection into a wellbore via a drill string.

3. The apparatus of claim 1 wherein the fluid containing the pressure pulsations is transmitted through a fluid conduit, and wherein the pulsation dampener is fluidly connected along the fluid conduit.

4. The apparatus of claim 1 wherein the pressure sensor is a first pressure sensor, and wherein the system further comprises a second pressure sensor operable to generate signals or information indicative of the gas pressure within the pulsation dampener.

5. The apparatus of claim 1 wherein the pulsation dampener comprises:
a chamber;
a first port fluidly connected with the gas source; and
a second port fluidly connected with the fluid.

6. The apparatus of claim 1 wherein the pressure regulator is fluidly connected between the gas source and the pulsation dampener, and wherein the pressure regulator is operable to control the gas pressure within the pulsation dampener by selectively:
transmitting the gas from the gas source into the pulsation dampener; and
relieving the gas out of the pulsation dampener.

7. The apparatus of claim 1 wherein the pressure regulator is operable to automatically maintain the gas pressure within the pulsation dampener at an intended gas pressure with respect to the fluid pressure while the fluid pressure changes.

8. The apparatus of claim 1 wherein the pressure regulator is operable to automatically maintain the gas pressure within the pulsation dampener at an intended gas pressure with respect to the fluid pressure while the fluid pressure changes.

9. The apparatus of claim 8 wherein the pressure regulator is further operable to automatically incrementally change the intended gas pressure within the pulsation dampener until an optimal gas pressure within the pulsation dampener that causes the fluid to contain smallest pressure pulsations is reached.

10. The apparatus of claim 1 wherein the system comprises or is communicatively connected to a controller comprising a processor and a memory operable to store a computer program code, and wherein the controller is operable to:
receive the signals or information indicative of the fluid pressure; and
generate control signals or information for controlling the pressure regulator to control the gas pressure within the pulsation dampener to an intended gas pressure, wherein the control signals or information for controlling the pressure regulator are based on the received signals or information indicative of fluid pressure and the computer program code.

11. The apparatus of claim 10 wherein the controller is operable to determine an average fluid pressure based on the received signals or information indicative of fluid pressure, and wherein the control signals or information for controlling the pressure regulator are based on the determined average fluid pressure.

12. The apparatus of claim 1 wherein:
the pressure sensor is a first pressure sensor;
the system further comprises a second pressure sensor operable to generate signals or information indicative of the gas pressure within the pulsation dampener;
the system comprises or is communicatively connected to a controller comprising a processor and a memory operable to store a computer program code;
the first pressure sensor, the second pressure sensor, and the pressure regulator are communicatively connected with the controller; and
the processor is operable to:
receive the signals or information indicative of fluid and gas pressures; and
generate control signals or information for controlling the pressure regulator to change the gas pressure within the pulsation dampener to an intended gas pressure, wherein the control signals or information for controlling the pressure regulator are based on the received signals or information indicative of fluid and gas pressures and the computer program code.

13. An apparatus comprising:
a system for reducing magnitude of pressure pulsations within a fluid, wherein the system comprises:
a gas source;
a pulsation dampener fluidly connected with the gas source and along a fluid conduit transmitting the fluid containing the pressure pulsations;
a first pressure sensor operable to generate signals or information indicative of pressure of the fluid containing the pressure pulsations;
a second pressure sensor operable to generate signals or information indicative of pressure of gas within the pulsation dampener; and
a pressure modulator operable to automatically modulate the gas pressure within the pulsation dampener based on the fluid pressure while the fluid pressure changes.

14. The apparatus of claim 13 wherein the fluid is a process fluid configured for injection into a wellbore.

15. The apparatus of claim 13 wherein the fluid pressure is an average fluid pressure, and wherein the pressure modulator is operable to automatically maintain the gas pressure within the pulsation dampener at an intended gas pressure with respect to the average fluid pressure while the average fluid pressure changes.

16. The apparatus of claim 13 wherein the system comprises or is communicatively connected to a controller comprising a processor and a memory operable to store a computer program code, and wherein the controller is operable to:
receive the signals or information indicative of fluid pressure;
receive the signals or information indicative of gas pressure; and
generate control signals or information for controlling the pressure modulator to modulate the gas pressure within the pulsation dampener to an intended gas pressure, wherein the control signals or information for controlling the pressure modulator are based on the received signals or information indicative of fluid and gas pressures and on the computer program code.

17. A method comprising reducing magnitude of pressure pulsations within a fluid via a pulsation dampener while automatically changing pressure of a gas within the pulsation dampener to an intended gas pressure with respect to pressure of the fluid while the pressure of the fluid changes.

18. The method of claim 17 wherein the fluid is a process fluid being injected into a wellbore.

19. The method of claim 17 further comprising determining an average pressure of the fluid based on the pressure of the fluid containing the pressure pulsations, wherein the intended gas pressure of the gas within the pulsation dampener is automatically changed with respect to the average pressure of the fluid while the average pressure of the fluid changes.

20. The method of claim 17 further comprising automatically incrementally changing the intended gas pressure of the gas within the pulsation dampener until an optimal gas pressure of the gas within the pulsation dampener that causes smallest magnitude of the pressure pulsations is found.
